(19) United States
(12) Patent Application Publication
(10) Pub. No.: US 2024/0191772 A1
(43) Pub. Date: Jun. 13, 2024

(54) VIBRATION CONTROL

(71) Applicant: FSD ACTIVE LIMITED, Wick, Gloucestershire (GB)

(72) Inventors: Emma Hudson, Colyton, Devon (GB); Paul Reynolds, Colyton, Devon (GB); Christopher Hawkins, Colyton, Devon (GB)

(21) Appl. No.: 18/276,925

(22) PCT Filed: Feb. 11, 2022
(86) PCT No.: PCT/EP2022/053448

§ 371 Date: Aug. 11, 2023

(30) Foreign Application Priority Data
Feb. 12, 2021 (GB) 2101975.7
Oct. 22, 2021 (GB) 2115261.6

(51) Int. Cl. F16F 15/02; F16F 15/00

(52) U.S. Cl. CPC F16F 15/02; F16F 15/002; F16F 2232/08

(57) ABSTRACT

An active mass damper device for reducing vibrations is provided and comprises means for measuring instantaneous vibrations using an accelerometer, means for feeding this signal to a control unit and using this to drive an actuator. The actuator moves a mass block, the inertia of which generates a force which acts in such a way as to cancel out or dampen vibrations.

The present invention relates generally to devices, systems and methods for reducing vibrations in structures.

There is a significant need for new methods to control vertical vibrations in modern floors, staircases, footbridges and other civil structures, which are increasingly susceptible to excitation by normal in-service usage from human occupants. Such vibrations might cause annoyance to and subsequent complaints from human occupants or might cause degradation or failure of vibration-sensitive equipment. Hence, there is a need for effective remedial measures to control vibrations when they occur.

In addition, the structural efficiency and hence cost and sustainability of many modern civil structures supporting humans is now governed by vibration serviceability considerations; an effective technology for vibration control may lead to significant savings in both financial cost and carbon footprint of new structures.

The present invention seeks to provide improvements in or relating to management of vibration in structures.

An aspect of the present invention provides an active mass damper device for reducing vibrations, comprising means for measuring instantaneous vibrations using an accelerometer, means for feeding this signal to a control unit and using this to drive an actuator, in which the actuator moves a mass block, the inertia of which generates a force which acts in such a way as to cancel out or dampen vibrations.

A further aspect provides a method for active mass damping to reduce vibrations, comprising measuring instantaneous vibrations using an accelerometer, feeding this signal to a control unit and then using this to drive an actuator, the actuator moves a mass block, the inertia of which generates a force which acts in such a way as to cancel out or dampen the vibrations.

Aspects and embodiments of the present invention may provide or relate to an Active Mass Damper (AMD) device/method is designed to achieve vibration reductions.

This may be achieved by measuring the instantaneous vibration of the floor using an accelerometer, feeding this signal to a control unit and then using this to drive an actuator.

The actuator moves a mass block, the inertia of which may generate a force which acts in such a way as to cancel out (or dampen) the vibrations.

The actuator may comprise a motor, for example one or more iron core and/or one or more ironless motors.

In some embodiments, for example, one or two motors are attached to a rigid back plate.

An entire AMD unit may be contained within a single enclosed box/frame that can, for example, easily be attached to the structure and left to run autonomously.

The device may be permanently connected to the internet so that it can, for example, upload performance data, receive firmware updates and report faults and failures to a central monitoring service.

Devices or apparatus formed in accordance with the present invention may comprise a controller, for example a printed circuit board (PCB).

In some embodiments a controller is provided and comprises multiple (two, three or more) CPU's with separation of tasks. The tasks may, for example, comprise one or more of: time critical controller functionality on one CPU; analysis of key signals on one CPU; communication with remote data server on another CPU.

A controller may provide for mixed use of various communication protocols between the CPUs and a servo drive. The communication protocols may, for example, include one or more of: analogue signals for high-speed command signals; dedicated simple digital signals for critical error status flags; and industrial ethernet protocols for more detailed messages.

In some embodiments a controller includes current monitors on each of a plurality of motor phases to allow for detection of any malfunction on any single phase.

Devices formed in accordance with the present invention may comprise relays for each of a plurality of motors to allow for a single motor to be deactivated whilst still powering the other without causing excess currents in that motor. In some embodiments a ‘limp mode’ can be activated to achieve some degree of control and avoiding total unit failure.

Some embodiments comprise an integrated DC rectifier with appropriate filtering and smoothing to provide power to the servo drive and other key electronics components, with capacity for voltage fluctuations caused by braking in the linear motors.

Components in AMD units formed in accordance with the present invention may, for example, comprise one or more of the following:
power electronics
motor that drives a mass block vertically
stiff frame assembly
lockable and tamper proof exterior case
suspension springs
linear bearings to ensure vertical motion only
soft end stops to prevent damage and loud noises in case of mass over-ranging
accelerometer
displacement transducer to determine the position of mass block
control computer
network connection

Some aspects and embodiments are configured, adapted or suitable for interior usage. Some aspects and embodiments are configured, adapted or suitable for exterior usage; for example by providing an enclosure with some form of ingress protection.

The present invention also provides a building or structure provided with one or more devices and/or arrangements as described herein.

### Power Electronics

Input power may be provided by single phase electricity for ease of installation within buildings. The system may accommodate both a nominal 230V+/−10%, with frequency of 50 Hz+/−1%, as well as 120V+/−6%, with a frequency of 60 Hz+/−1% or as appropriate for the mains network of the country of installation. In some cases, three phase input power may be utilised as appropriate for the installation location.

In some embodiments the control electronics are physically separated from the moving components to avoid any potential issues with electronic components being damaged by moving components.

Mains filters, fuses and power converters may be included as necessary to provide appropriate safe and good quality power for internal components such as motor servo drive, microprocessors and other PCB components, sensors, etc.

### Actuator and Moving Mass Block

In some embodiments the specific mass of the mass block is considered a design parameter and its acceleration profile is related to the motor force through Newton's Law:

Force=Mass*Acceleration

Therefore, a higher mass would require lower accelerations (and hence lower displacements) to achieve the same force.

| | Typical | |
|---|---|---|
| Property | Values | Units |
| Maximum height of assembled unit | 100-800, | mm |
| (in direction of movement of mass) | e.g. 400 | |
| Vertical moving mass | 5-150, | kg |
| | e.g. 30 | |
| Minimum force capacity at dominant | 25-2000, | N |
| structural continuous frequency, e.g. 4 Hz, | e.g. 400 | |
| continuous | | |
| Minimum force capacity at significantly | 5-500, | N |
| higher frequency, e.g. 50 Hz, continuous | e.g. 100 | |
| Minimum peak force capacity | 100-5000, | N |
| | e.g. 1000 | |
| Minimum peak-to-peak displacement possible | 10-600, | mm |
| | e.g. 150 | |
| Maximum time delay between structural | 0.1-50, | ms |
| acceleration and acceleration of moving mass | e.g. 2 | |
| Maximum idle power | 1-100, | W |
| | e.g. 50 | |
| Minimum mean time to failure for any | 2-50, | years |
| component | e.g. 15 | |
| Maximum noise under any operating | 10-60, | dB |
| conditions at distance of 1 m | e.g. 30 | |

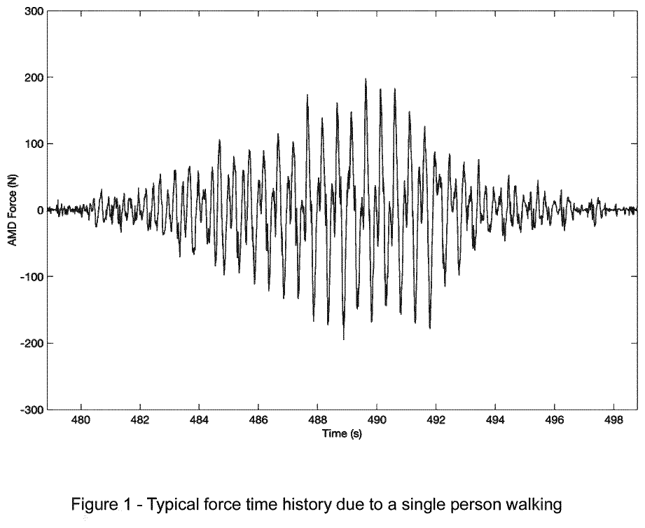

FIG. 1 shows a typical force time history due to a single person walking.

The motion of the moving mass block will very rarely be purely sinusoidal. The nature of the forces from pedestrian footfalls that the AMDs are designed to control is that they are composed of multiple harmonics and transient in nature, therefore even when the primary response of the structure is in a single mode the usual case for the AMD will be pseudo-harmonic with impulsive responses superimposed.

Additionally, in cases of high force and high displacement the control algorithms are designed to modify the demand signal to avoid the mass hitting the end stops. This could result in fairly sharp transient peak force demands.

In some embodiments key priorities are:
minimise the time delay between the control circuitry generating the desired motor command signal (force, displacement etc.) and the resultant motion of the motor
minimise additional harmonics that are not present in the drive signal
minimise friction to allow low displacement/high frequency forces
minimise maintenance requirements

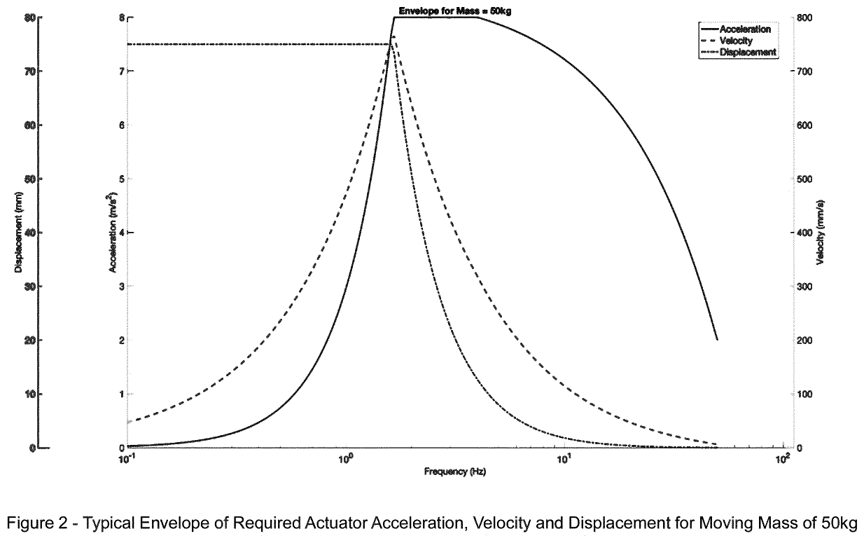

A typical acceleration/velocity/displacement envelope profile is shown in FIG. 2.

The presented graph is for a 50 kg mass. In the case that a different mass is used the acceleration will scale with the mass as appropriate to achieve a given force demand.

### Frame

Single rigid frame consisting of two compartments—one for the moving components—actuator/mass block/bearings/springs etc., and one for the power electronic components.

Appropriate cable management must be planned to allow cables to pass between each compartment as needed, factoring in the full travel of movement of the actuator.

Typical mounting of the AMD will be by bolting to the underside of the structure, by fixing to the top of the structure, or by attaching sideways, for example to the web of an I-beam.

When bolted to the underside of the structure or attached sideways, the attachment plate and attachments (bolts/welds) must be sufficiently strong to withstand shock forces from the mass block being driven into the end stops at maximum force. Stress and fatigue analysis must be performed to ensure that under both normal operating conditions and infrequent (frequency of occurrence to be specified at a later date) ‘banging against end stops’, forces are within safe region.

In some embodiments, when operating on top of a structure the AMD requires bolting to a sufficiently heavy static mass that the dynamic forces from the AMD do not result in any movement of the frame.

A means of access to the inner components, e.g. through windows/openings in the frame, may be provided for in-situ commissioning and maintenance inspection purposes. Internal or external lighting must allow clear visibility of the key components along the full stroke.

A lock or other device to restrict access to the main compartments when the AMD is in operation may be included to prevent unauthorised entry which might result in injury.

### Suspension Springs

Tension or compression springs may be provided, joining the moving mass block to the frame exterior, such that the mass block rests at the centre of the available stroke when zero input force is applied to the actuator.

The natural frequency of the combined mass/spring system may be sufficiently low to be below the natural frequency of the first dominant vertical mode of vibration of the structure, but not so low that large displacements occur at low frequencies. Typical values may, for example, be between 0.1 Hz and 10.0 Hz, e.g. 1.0 Hz.

Spring resonances that inhibit control effectiveness may be minimised through use of supplementary damping, e.g. through additional rubber sheath or spring wrap.

In the case of compression springs, some restraint against buckling may be necessary; for example by providing a low friction sleeve.

### Bearings

The bearings may maintain the tolerance required for the displacement transducer and linear motor chosen over the design life of the AMD with no maintenance requirements within that period, e.g. any lubrication required to be applied once only.

### Sensors

The following sensors may be provided in the AMD unit:
one or more accelerometers to measure motion of the structure
this provides a key measurement for the feedback control algorithm
one or more displacement transducers on the moving mass block
this indicates the absolute position of the mass/actuator in its stroke. This is necessary feedback for certain actuator technologies, and in all cases will help to ensure optimal performance whilst avoiding hitting the end stops
one or more temperature sensors on motor (this is needed to ensure that the motor does not overheat when in operation which could result in permanent damage to the motor and pose a safety hazard).

### External Interfaces

One or more status LEDs on exterior frame may be provided to indicate power and fault status.

External connection port (Ethernet, USB, other as appropriate for specific hardware) may be provided to simplify connecting to control software with a laptop on site for maintenance/configuration/testing.

A network connection (e.g. Ethernet) may be included to facilitate connection to an external network, e.g. corporate network or 4G router.

### Software

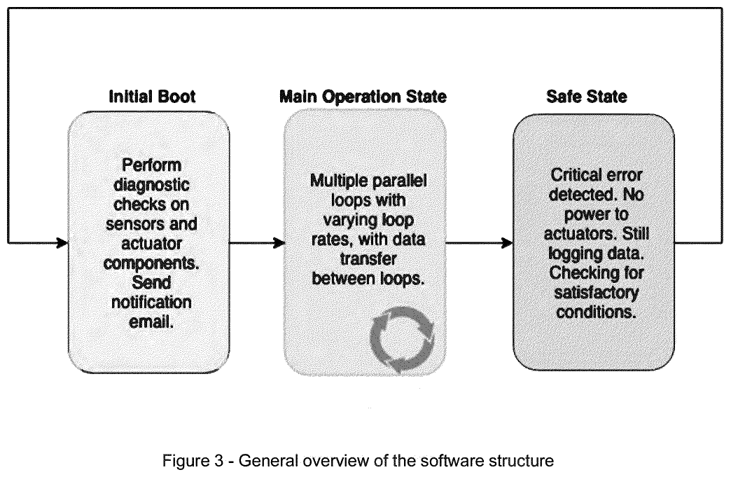

A general arrangement of an example structure is presented in FIG. 3.

The booting process may comprise of validating sensor inputs and proper actuator function through a series of brief tests lasting no more than 5 minutes in total, for example.

All sensors can undergo automatic evaluation throughout operation to ensure proper working state. These may involve:
a check that the signal is within maximum/minimum limits expected (i.e. no signal clipping)
a check that variance of the signal over a 5 second window is of the expected order of magnitude (i.e. sensor hasn't failed and picking up electrical noise)

A typical example of a boot test would be gradually increasing actuator force to move the mass slowly towards each upper and lower limit of movement in turn whilst checking that displacements and accelerations are within expected range.

The main operation state may comprise of one time critical control loop running at e.g. 1000 Hz. Key operations in this loop will be implementing discrete state space control algorithms (typically 12th order) plus nonlinear control logic including averaging over 1 second blocks of data and clipping of data signals.

A network connection for communication with external server may be required, for example to log critical data and to provide firmware updates remotely.

Less time-critical processes such as on-going sensor validation checks, data logging, file uploads, email etc, may be performed in slower, lower priority loops.

Signals to be logged:
structural acceleration
absolute position of moving mass
drive voltage to actuator
all error states

### Design Details

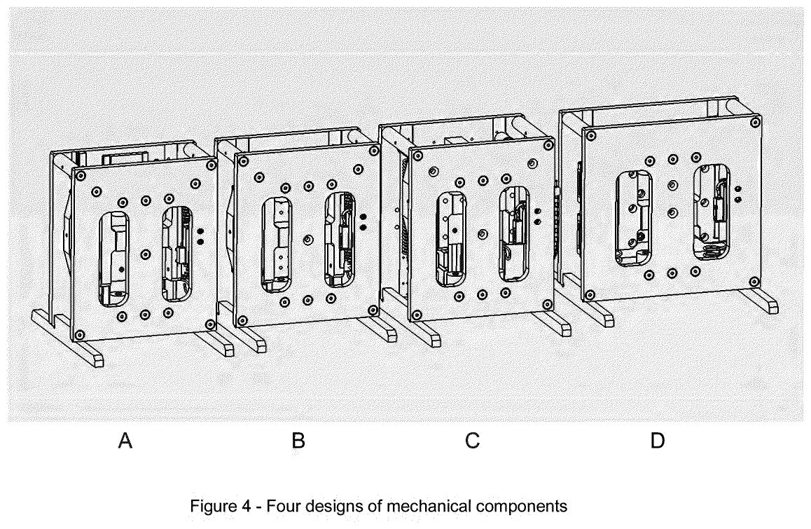

Four examples designs of the mechanical components only are presented in FIG. 4, denoted A-D from left to right.

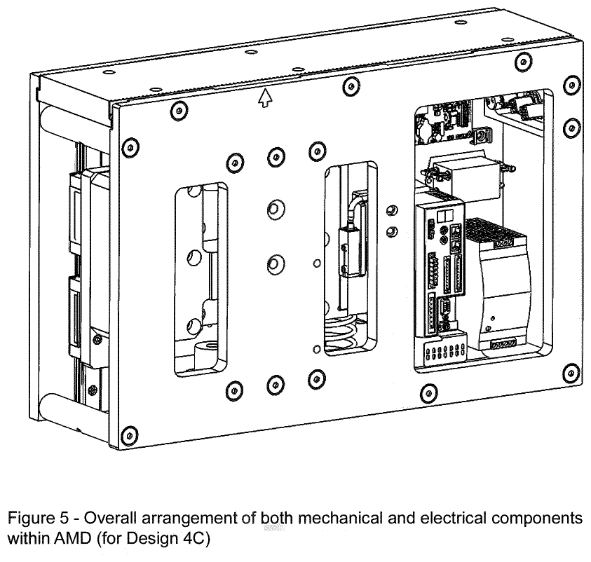

FIG. 5—Overall arrangement of both mechanical and electrical components within AMD (for Design C).

Features common to all designs
stiff back plate onto which all major components are attached, enabling easy assembling and alignment
pillars at each corner to provide connection with a stiff front plate
the front plate has access voids cut out to allow visibility to key components
during operation a solid case surrounds and encloses the entire frame
sturdy end blocks at top and bottom with rubber attached to form shock absorbers
these are notched to reduce reliance on bolts for mechanical fixity
stress analysis performed with high impact load, assuming a worst case of the mass being driven into the end stops under an error condition
displacement encoder strip mounted to the moving mass block and encoder read head mounted to the static frame via an adjustable adapter plate, thereby eliminating cable movement for the displacement measurement
all have total height 400 mm to fit within a wide range of applications on site
locking pin through the front plate to hold the mass at mid-height to prevent the mass from moving during transportation
locking pins through the front plate to hold the mass at top or bottom positions to help with inspection/maintenance on site

Features specific to Design A
a single ironcore linear motor:
the magnet strip is attached to the stiff back plate
the motor coils are attached to the moving mass
this allows for 150 mm total travel, 10 mm of which is reserved for deflection of the rubber stops at the end limits
the ironcore motor results in a large attractive force between the magnet strip and the motor coils which must be managed by the bearings, maintaining a tight tolerance on the air gap between aforementioned magnets and coils
two tension springs to suspend the mass from the top of the frame
two linear bearings with four total carriages (two on each guide rail) mounted either side of the linear motor
mass block of 30 kg (total moving mass)
cable from the motor coil is guided through to the electronics side of the AMD unit via a cable track

Features specific to Design B
similar to design A but uses different components (motor, bearings, displacement encoder) from different suppliers

Features specific to Design C
two ironless linear motors:
the magnets are attached to the stiff back plate
the motor coils are attached to the moving mass block
this allows for 150 mm total travel, 10 mm of which is reserved for deflection of the rubber stops at the end limits
the ironless motors
do not generate any attractive force between the motor magnets and coils
generate a lower force and hence two motors are required for the same specification
higher initial cost to manufacture because two motors required
require more depth than an ironcore based design (though this is not a critical dimension)
two tension springs to suspend the mass from the top of the frame
one linear bearings with two total carriages mounted in between the two linear motors
mass block of 30 kg (total moving mass)
cables from the motor coils are guided through to the electronics side of the AMD unit via a cable track

Features specific to Design D
two ironcore motors:
the magnets are attached to the moving block
the motor coils are attached to the stiff back plate
this allows for 140 mm total travel, 10 mm of which is reserved for deflection of the rubber stops at the end limits
two ironcore motors, each of lower individual force capacity, must be used in this arrangement to fit within the space available
resulting in a more expensive initial design
but the cables to the motor coil are now static, meaning that there are no moving cables and no cable track is needed, resulting in reduced maintenance requirements
mass block of 33 kg (total moving mass) to compensate for the reduced total travel available relative to Designs A, B and C
two linear bearings mounted on the outer edges of the two linear motors, needed to maintain tolerances subject to the large attractive forces from the ironcore linear motors
this results in a wider design (though this is not a critical dimension)
two compression springs to support the mass block at mid-height
two voids are cut out of the main mass block to allow these to extend within the body of the mass block and enable compression over a greater distance to achieve the required total stroke
a sleeve of low friction PTFE (or similar) within the mass block to support the long length springs and prevent buckling
the compression springs have a longer expected operating life than the tension springs as they do not have the weakness of stress concentrations around the hanging point that tension springs do

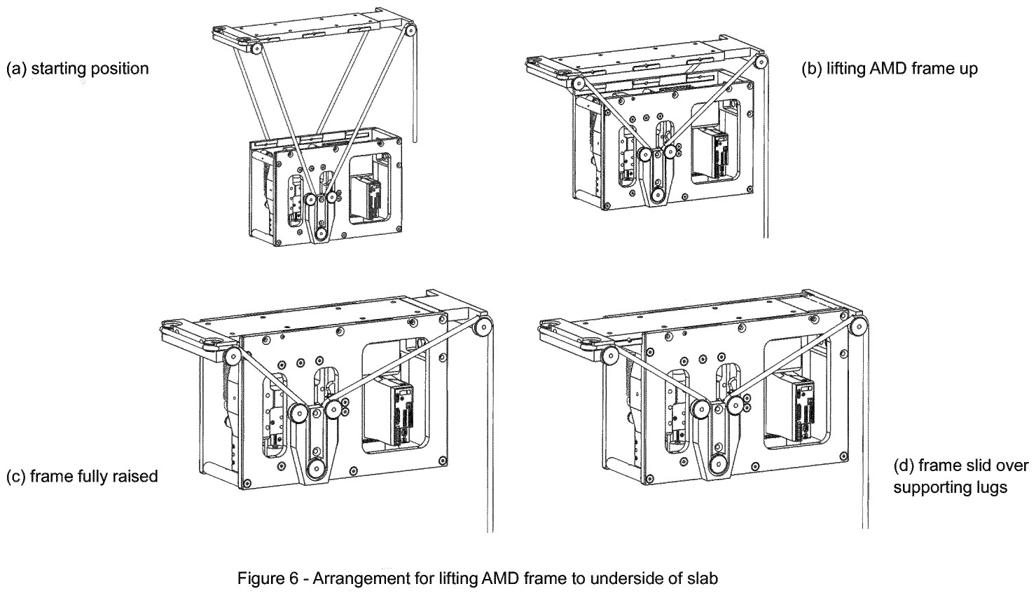

Lifting arrangement when mounting to the underside of a slab
1. A stiff top plate is fixed to the underside of the slab
a. This features three protruding ‘lugs’ on each of the two long sides which will ultimately support the rest of the frame
2. Two temporary components are attached to the short edges of the top plate, housing small pulley wheels, as per FIG. 6a
3. Two temporary components are attached to the front and back sides of the AMD frame, also housing small pulley wheels
4. Cable is passed through the pulley arrangement and used to raise the AMD frame, as per FIG. 6b, by a winch or similar.
5. The AMD frame is lifted to the top position, as per FIG. 6c, and then held in that vertical position
6. The AMD frame is then slid horizontally by manual handling of the device, allowing it to come to rest on top of the lugs on the top attachment plate, as per FIG. 6d
7. Bolts are used to secure the frame in place
8. The components housing the pulley wheels on both the top adapter plate and the front and back sides are removed
9. The external cover/case is lifted into position, covering the unit, and bolted in place

The arrangement of pulleys gives a mechanical advantage of 4.0. The overall mass of the complete AMD is approximately 60 kg, meaning that an equivalent mass of 15 kg must be lifted.

The advantage of this approach is that it is possible for a single individual to install (and by a similar procedure, uninstall) the AMD to/from an elevated position.

### Electrical/Software Design

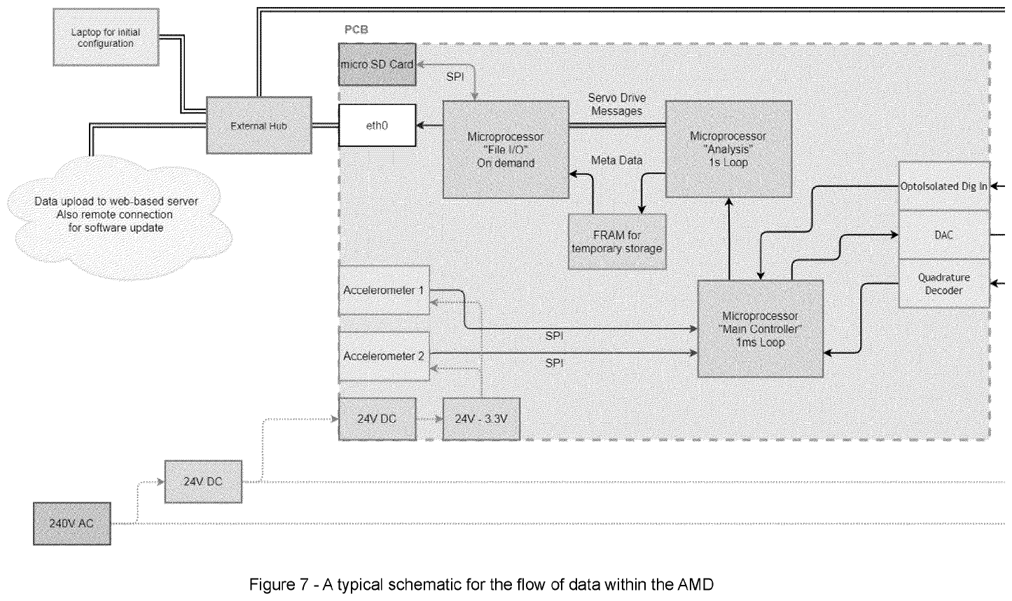

A typical schematic for the flow of data within the AMD is presented in FIG. 7.

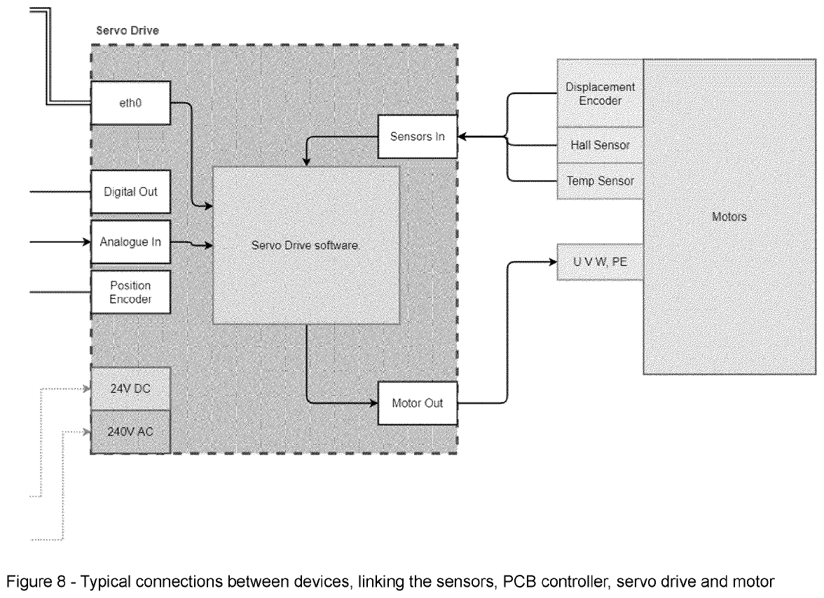

FIG. 8 shows typical connections between devices, linking the sensors, PCB controller, servo drive and motor.

### Example Features

high performance processor to perform time critical control loop with 1 ms loop period
low noise accelerometers with digital communication, mounted on separate PCBs that can be readily swapped out in case of component failure
two accelerometers used to allow:
signal comparison and verification to ensure proper measurement
improved low noise threshold when averaging the two measurements
option to maintain control from a single accelerometer if one accelerometer fails
CAN communication from PCB to servo drive, avoiding analogue signals, making the system more robust to electromagnetic interference and noise in particular those generated by the linear motors that are in close proximity
separate processor to
log critical data to file and communicate with external file server
host a web interface that allows for remote updating of firmware
SD card for local storage of data in case of communications failure, with capacity for over 1 year of data
watchdog chip to monitor both file I/O chip and main controller chip and restart these if they do not respond within the allocated time
connection for local laptop to view key data during initial commissioning and maintenance visits
network connection and software interface for remote monitoring of system performance, installation of firmware/software updates and automatic fault reporting.

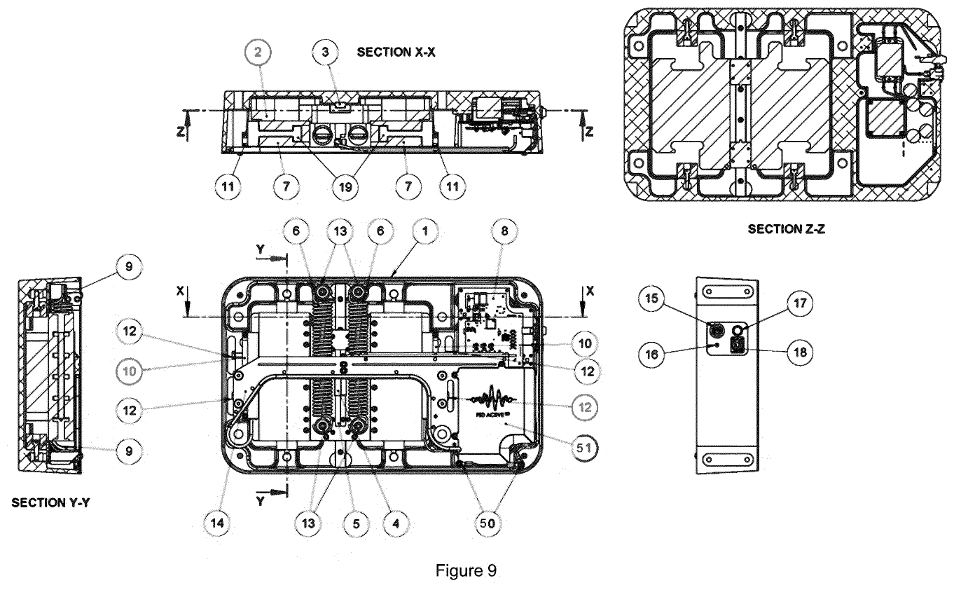

FIG. 9: AMD MODULE WITH FRONT COVER REMOVED
1. Enclosure
2. Mass block
3. Linear bearing
4. Position encoder read head
5. Position encoder tape
6. Tension springs
7. Linear motor magnet tracks
8. PCBs (parent+child)
9. End stops
10. Motor adjusting plates
11. Motor adjusting screws
12. Motor clamp screws
13. Spring pins
14. Cable carrier plate
15. Network connector
16. LED
17. Cable gland
18. Fuse holder
19. Linear motor coils
50. Earthing point for connecting the front cover to the enclosure
51. Plastic cover to form a physical shield for high voltage components

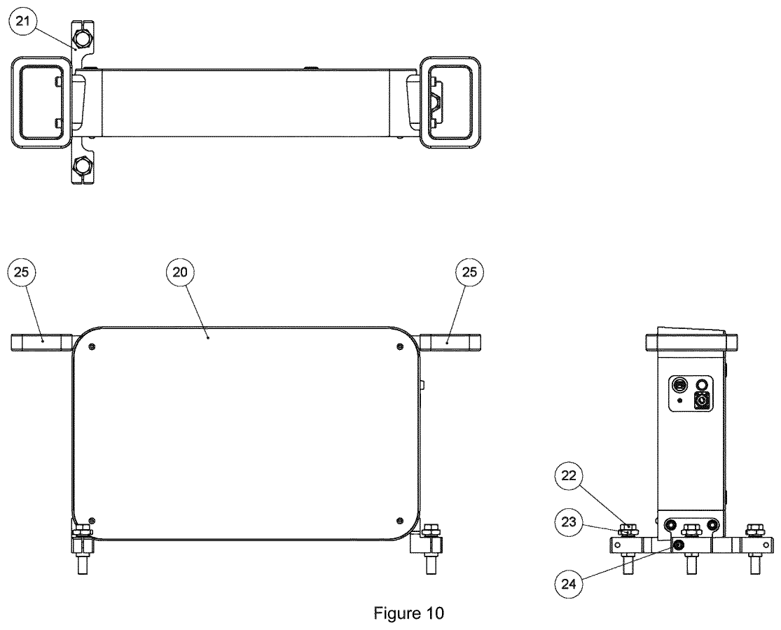

FIG. 10: AMD MODULE WITH FLOOR MOUNTS
20. FRONT COVER
21. SUPPORT LEGS
22. FIXING BOLTS
23. ADJUSTABLE FEET
24. FEET CLAMP BOLTS
25. CARRYING HANDLES

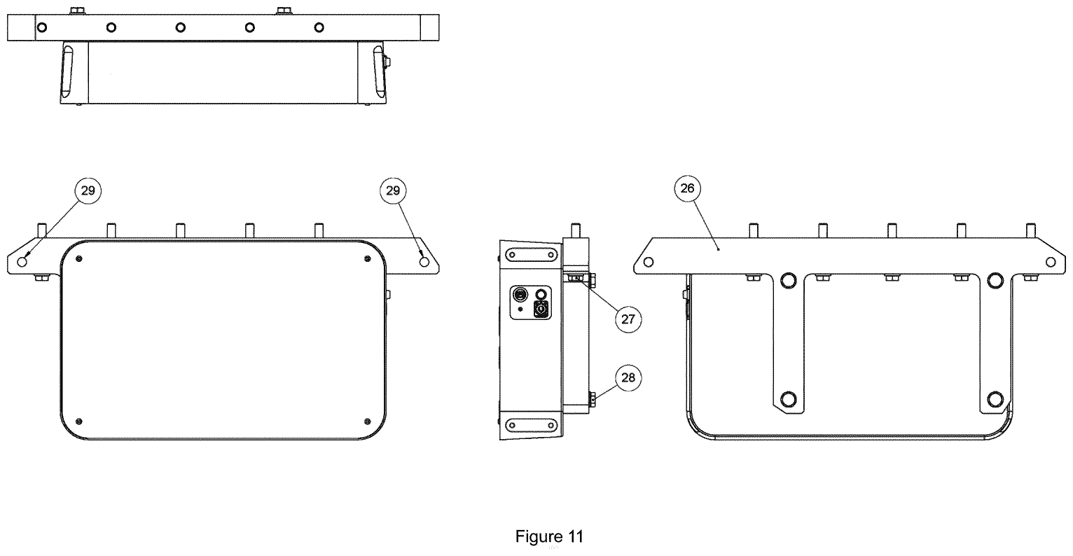

FIG. 11: AMD MODULE WITH CEILING MOUNT
26. CEILING MOUNT ADAPTER
27. CEILING MOUNT BOLTS
28. AMD SUPPORT BOLTS
29. INSALLATION HOLES

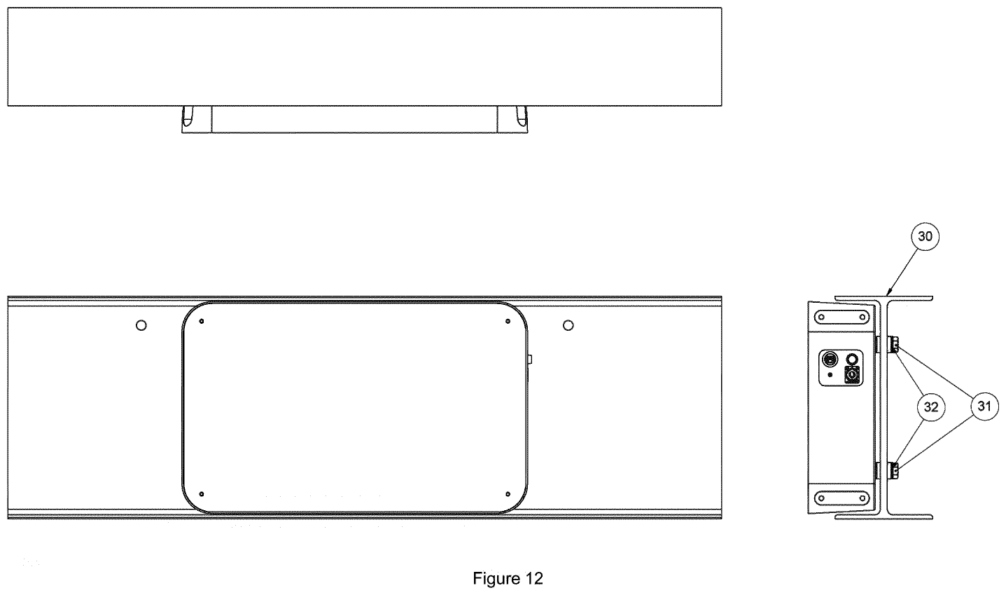

FIG. 12: AMD MODULE BEAM MOUNT
30. STRUCTURAL I-BEAM
31. FIXING BOLTS
32. SPHERICAL WASHERS

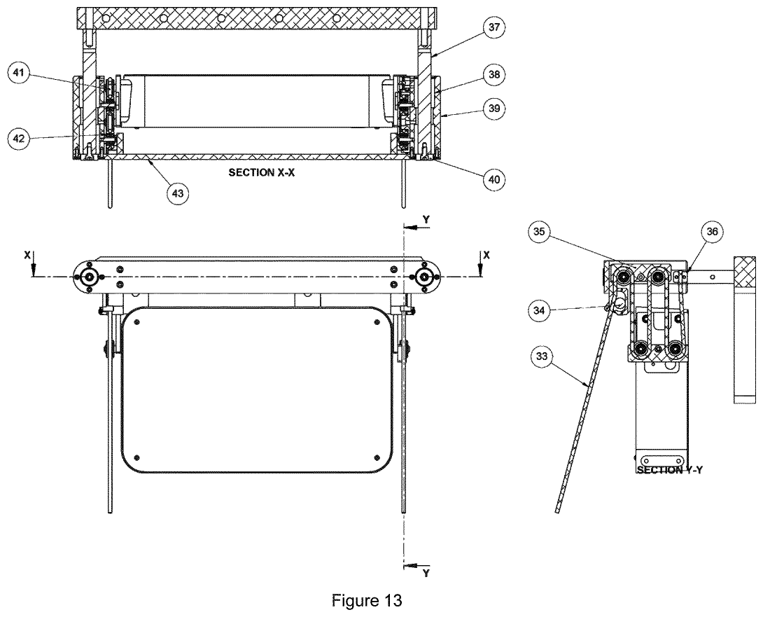

FIG. 13: AMD MODULE INSTALLATION PULLEY HOIST
33. ROPE
34. ROPE BRAKE WHEEL
35. ROPE RETAINING GUIDE
36. ROPE CLAMP BLOCK
37. GUIDE SHAFT
38. PLAIN BEARINGS
39. BEARING HOUSING
40. END STOP
41. ROPE PULLEY
42. PULLEY BALL BEARINGS
43. TIE PLATE

Referring to FIG. 9, enclosure (1) comprises precision machined faces that many of the key components fix to. This is sufficiently stiff as to transmit the dynamic forces generated by the internal motion of the mass block (2) without introducing any additional dynamics within the frequency range of interest, namely 0.5 Hz to 100 Hz. The enclosure is also designed to withstand the forces from impacts of the mass block against the provided end stops (9), in the unlikely event that an internal software error results in undesirable motor forces. The total height of the enclosure has been kept below 400 mm so that it can fit inside the web of commonly used I beams.

The end stops (9) have been designed with sufficient net stiffness to yield maximum design compression at the design impact force from the linear motors (7, 19) driving the moving components beyond normal maximum travel. Cut outs in the mass block (2) allow for the height of the end stops to maximise travel of the moving parts within the limited total height.

The linear motor coils (19) fix to the sides of the enclosure (1) whilst the linear magnet tracks (7) are fixed to the internally moving mass block (2). This eliminates moving cables and hence the need for any cable trays, whilst maximising product life. The motors are arranged either side symmetrically about the centreline of the linear bearings (3). Cables from the motor on the far side of the enclosure are carried around the mass block (2) and other moving components by a cable carrier plate (14) to their respective terminals on the PCB (8).

Ironless motors have been used to avoid all cogging forces and magnetic attraction forces. The avoidance of cogging forces helps improve the quality of the force signal that can be generated at low amplitudes which can be critical for particularly vibration sensitive facilities. The avoidance of magnetic attraction forces helps reduce the wear on bearings and improve product life. Fine adjustment of the alignment of the motor coils (19) to mitigate the potential negative impact of necessary machining tolerances is achieved through adjustment plates (10) and screws (11). Once alignment is achieved, the position of the motor coils (19) is then fixed with motor clamp screws (12).

A single linear bearing (3) with multiple carriages provides sufficient restraint against out of plane movement, whilst also keeping friction and noise low. The linear bearings have also been designed with a long life maintenance free, without need to provide additional lubrication, which is key for a remotely deployed system.

Tension springs (6) provide suspension of the moving parts at the midpoint of the stroke under self weight. These have a sufficiently high inherent natural frequency that resonance induced by motor forces in the frequency band of interest is minimised. Being tension springs rather than compression springs means that no additional supporting sleeves to prevent buckling are needed, thus reducing friction and noise. These are fixed between the enclosure (1) and mass block (2) by spring pins (13) positioned to accommodate the initial free length of the springs (6).

A position encoder, comprising read head (4) and tape (5), measures the movement of the mass block relative to the enclosure and other static components. The non-contact encoder technology helps reduce wear and increase product life. The position encoder read head (4) is mounted to the cable carrier plate (14) via adjustable block and screws to accommodate any machining tolerances. The cable from the encoder read head (4) is also transferred over the moving parts of the AMD to its terminal on the PCB (8) via the cable carrier plate (14). The position encoder tape (5) is aligned by a machined groove in the mass block (2) and located directly above the linear bearing (3) to minimise the impact of any potential asymmetric movement.

The PCB (8) comprises the following key components:
2No. accelerometers for measuring structural vibrations
Connections for external sensors (displacement, temperature, Halls, current)
1No. servo drive for connection to the 2No. motors (7, 19)
3No. microprocessors for running multiple tasks in parallel with varying real-time requirements
Internal storage (SD card) for local data file saving

External communication interfaces, namely RJ45 for connection to internet connected remote server and RS485 for daisy chaining multiple AMD units on-site
Power electronics to manage demand from servo drive and other electronics components
Two physical boards that are vertically offset to increase the available space within the enclosure (1) for physical connections to devices such as position encoder (4) and motors (19)

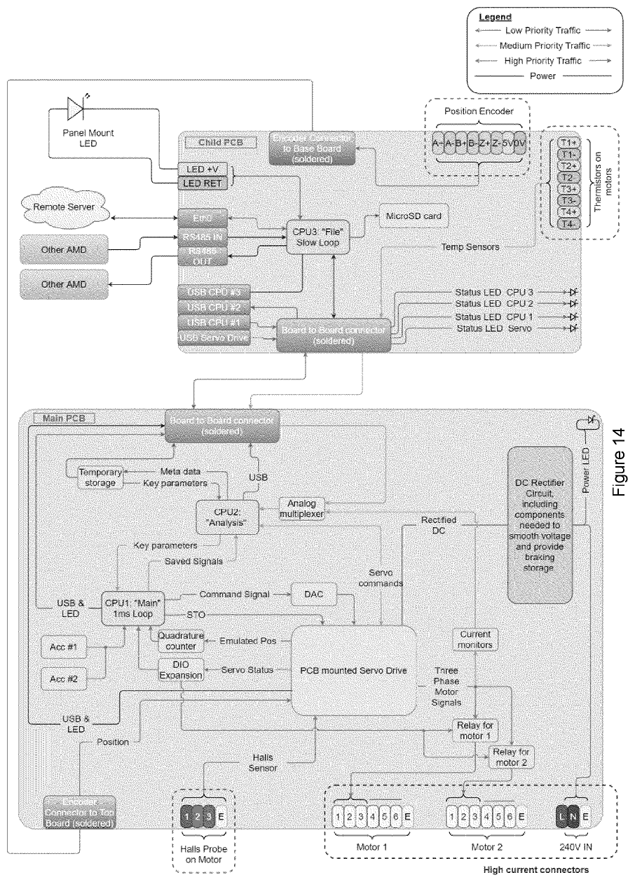

Referring also to FIG. 14, the example PCB (8) incorporates the servo drive for both motors (7, 19) directly, rather than as a separate component with external wiring between as this simplifies assembly process. The large and thick backplate of the enclosure (1) acts as a heat capacitor/sink for the servo drive meaning that additional fans or other cooling components are not needed. To accommodate the height of the servo drive on the underside of the PCB, the mounting points for the PCB corners are elevated accordingly.

Multiple CPUs are provided. Communication to the servo drive is by both digital and analogue signals, managed by two of the onboard CPU's. The most time critical CPU sends the drive command signal by analogue signal and monitors the binary digital outputs from the servo drive indicating any error conditions that have been detected. A second CPU sends/receives ModBus/CAN/etherCAT signals which provide more information but at a slower speed. This CPU also collects and analyses all real-time sensor data for error checking, with metadata stored in a temporary storage area which has shared access with the third CPU. This third CPU uploads key metadata to an external data server to allow for more comprehensive system performance checks, possibly triggering alerts that maintenance could be required to avoid future component problems.

Some embodiments are provided with one or more forms of redundancy. For example a plurality (e.g. two) accelerometers, with error checking and the ability to turn off/ignore one (or more) if a problem is detected. A plurality of motors (e.g. two, run in parallel) could be used, with means for detecting problems also provided. If a problem with a motor is detected then that motor can be shut down and the other motor could be throttled back—this could be used to avoid damage to both motors. An alert could then be sent in the event of problems being detected; but the system can remain active whilst awaiting maintenance.

The use of multiple physical temperature sensors on each motor and throughout the AMD unit, in combination with indirect measurements of temperature via current monitors mean that the chance of motor failure is significantly reduced. If the temperature exceeds a threshold level then the operation of the motor may be limited, for example by reducing the current sent to the motor. Alternatively or additionally, current sensors and relays allow the AMD to detect a partial failure of any single phase of a motor and run in a ‘limp’ mode with only one motor activated should a problem in the other motor occur. Upon ‘limp’ mode being activated a warning message is issued to the remote server for attention and the unit operates at half (for example) capacity. This still provides a significant level of control performance until the maintenance team arrives on site.

Three independent watchdog functions track each CPU and restart if they do not respond with an allocated time, allowing for system recovery in case of unforeseen software error. Internally accessible USB ports allow for initial firmware uploading and on-site commissioning checks/updates to be performed.

In addition to bolting the AMD unit directly to the web of a beam, two other mounting techniques have been designed. Firstly, for mounting to the underside of a slab there is a ceiling mount adapter (FIG. 11). This includes installation holes (FIG. 11) for use with a pulley hoist system (FIG. 13). This features a set of bearings on each side of the AMD, arranged to achieve a mechanical advantage ratio of 4. A rope brake wheel locks the device in place to allow simple and controlled lifting and lowering. A set of linear bearings (FIG. 11) allow the unit to slide next to the adapter mount (FIG. 11) or beam (FIG. 12) as needed for each installation location.

The AMD can also be mounted on the top side of a floor surface. Three fixing bolts (FIG. 10) attached to support legs (FIG. 10) and can be levelled with adjustable bolts.

The device can then either be bolted into a surface for permanent installation, or left free-standing for a temporary installation, e.g. for demonstration purposes. Carrying handles (FIG. 10) help with manual handling of the device.

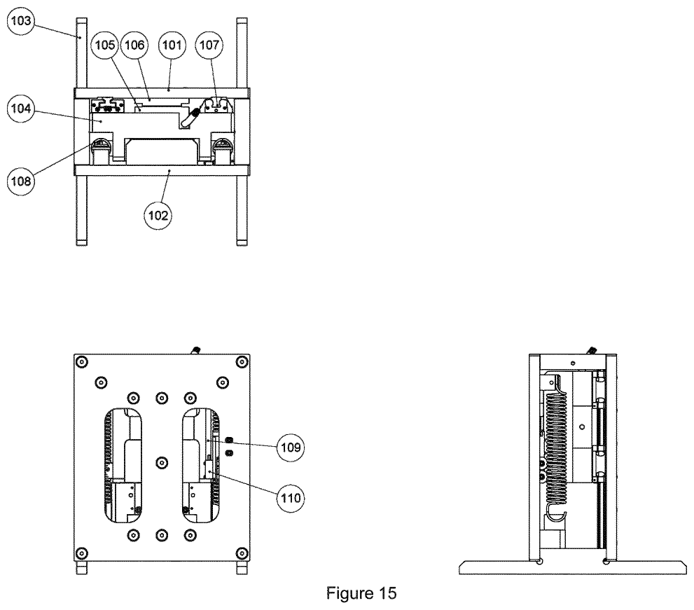

FIG. 15: An example of an ironcore motor (such as a KOLLMORGEN IRONCORE)
101. BACKPLATE
102. FRONTPLATE
103. SUPPORT LEG
104. MASS BLOCK
105. LINEAR MOTOR
106. LINEAR MAGNET TRACK
107. LINEAR BEARING
108. TENSION SPRING
109. ENCODER TAPE
110. MAGNETIC ENCODER

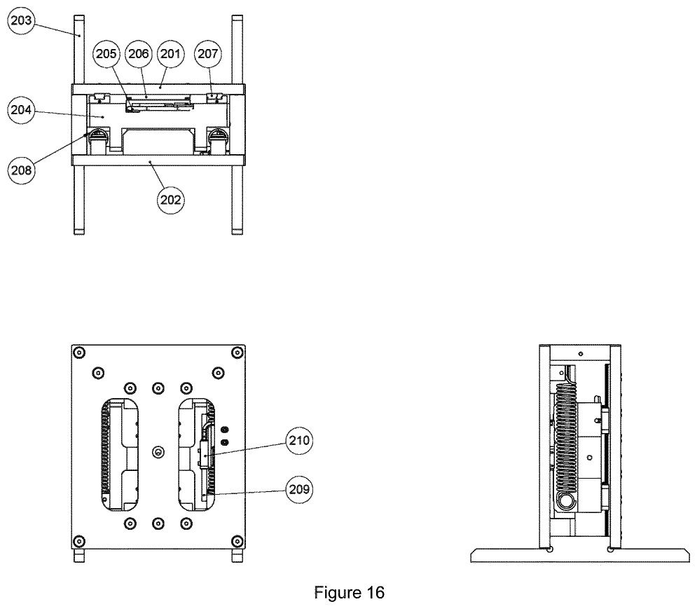

FIG. 16: An example of an ironcore motor (such as an AKRIBIS IRONCORE)
201. BACKPLATE
202. FRONTPLATE
203. SUPPORT LEG
204. MASS BLOCK
205. LINEAR MOTOR
206. LINEAR MAGNET TRACK
207. LINEAR BEARING
208. TENSION SPRING
209. ENCODER TAPE
210. MAGNETIC ENCODER

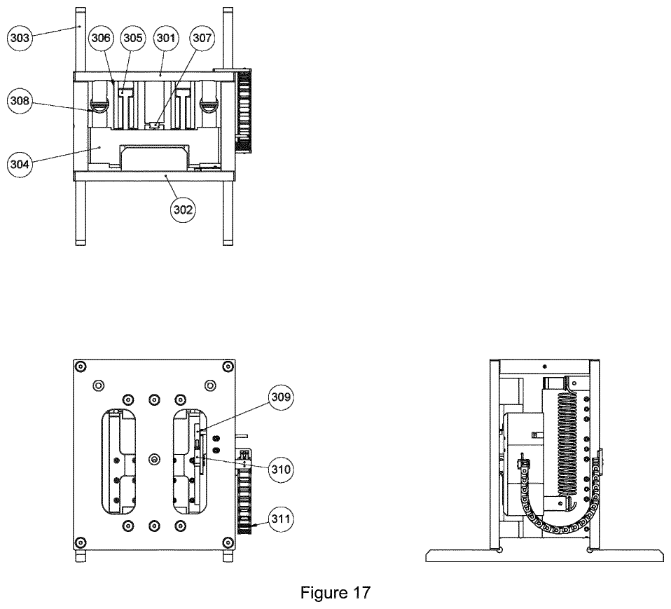

FIG. 17: An example of an ironcore motor (such as an AKRIBIS IRONLESS)
301. BACKPLATE
302. FRONTPLATE
303. SUPPORT LEG
304. MASS BLOCK
305. LINEAR MOTOR
306. LINEAR MAGNET TRACK
307. LINEAR BEARING
308. TENSION SPRING
309. ENCODER TAPE
310. MAGNETRIC ENCODER
311. DRAG CHAIN

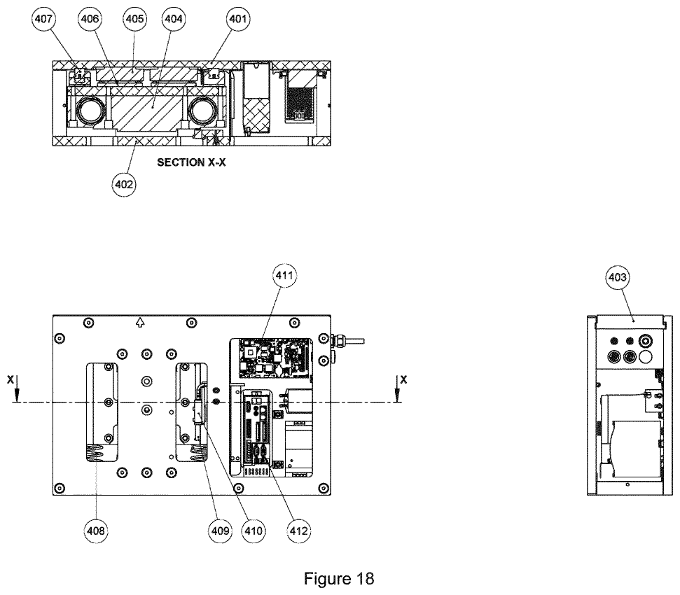

FIG. 18: An example incorporating compression springs (including a motor, for example of the type produced by ETEL)
401. BACKPLATE
402. FRONTPLATE
403. TOP PLATE
404. MASS BLOCK
405. LINEAR MOTOR
406. LINEAR MAGNET TRACK
407. LINEAR BEARING
408. COMPRESSION SPRING
409. ENCODER TAPE
410. MAGNETRIC ENCODER
411. PCB
412. MOTOR DRIVE

Other embodiments (not shown) may use one or more voice coil motors, for example.

Further embodiments may include one or more of the following:
Power cables from the motor, including Halls probe, and position encoder are brought past the moving components safely by tying to a plate. This is designed such that the motor connections run along the bottom edge for maximum supported distance up to the PCB connection towards the bottom area of the PCB which is separated for ‘high voltage’ connections. The position encoder cable runs along the top edge for maximum supported distance up to the PCB connection towards the middle of the PCB which is in a ‘low voltage’ area. This improves cable management by avoiding cables from crossing.
A cover is provided over the high voltage components to provide additional protection in cases where the front cover is removed whilst power is still provided to the AMD, and/or if an internal cable connection comes loose.
The PCB is raised relative to the back plate to which it is mounted due to the height of the PCB mounted servo drive. There is therefore a space between the PCB and the backplate around the servo drive, where an additional line filter can be located to provide necessary conducted emissions reductions.
There is an electrically conductive gasket between the front cover and the enclosure, which sits within a groove running parallel with the edge of the front perimeter of the enclosure which assists with electromagnetic radiation and also reduces long term dust ingress.

The example embodiments are described herein in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail herein. There is no intent to limit to the particular forms disclosed.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

All orientational terms, such as upper, lower, radially and axially, are used in relation to the drawings and should not be interpreted as limiting on the invention.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims.

The present invention is described, by way of example, with reference to the accompanying drawings.

Example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1.-31. (canceled)

32. An active mass damper system to reduce vibrations in a structure, the system comprising a stiff frame securable to a structure, the system further comprising one or more accelerometers which take instantaneous absolute measurements of vibrations in a structure, means for feeding the instantaneous absolute measurements to a control unit and using this to drive an actuator, in which the actuator moves a mass block substantially vertically in the stiff frame and the system comprises linear bearings to ensure substantially vertical motion of the mass block, the stiff frame transmits dynamic forces generated by the internal motion of the mass block to cancel out or dampen vibrations in the structure in use.

33. A system as claimed in claim 32, in which the device is contained within a single enclosed box/frame that can easily be attached to a structure and left to run autonomously.

34. A system as claimed in claim 32 and being permanently connected to the internet so that it can upload performance data, receive firmware updates and report faults and failures to a central monitoring service.

35. A system as claimed in claim 32 and comprising one or more of: power electronics;
a motor that drives the mass block vertically; a lockable and tamper proof exterior case;
suspension springs; soft end stops to prevent damage and loud noises in case of mass over-ranging; control computer; network connection.

36. A system as claimed in claim 32, comprising one or more iron-core motors.

37. A system as claimed in claim 32, comprising one or more ironless motors.

38. A system as claimed in claim 32, comprising a controller.

39. A system as claimed in claim 38, comprising a controller having multiple CPU's with separation of tasks.

40. A system as claimed in claim 39, in which the tasks comprise one or more of: time critical controller functionality on one CPU; analysis of key signals on one CPU; communication with remote data server on another CPU.

41. A system as claimed in claim 38, in which the controller includes current monitors on each of a plurality of motor phases to allow for detection of any malfunction on any single phase.

42. A system as claimed in claim 32, comprising a plurality of motors and a relay for each motor to allow for a single motor to be deactivated whilst still powering the other/s without causing excess currents in that motor.

43. A system as claimed in claim 42, in which a ‘limp mode’ can be activated to achieve some degree of control and avoiding total unit failure.

44. A system as claimed in claim 32, comprising an integrated DC rectifier with appropriate filtering and smoothing to provide power to a servo drive and other key electronics components, with capacity for voltage fluctuations caused by braking in linear motors.

45. A system as claimed in claim 32, comprising a plurality of motors, in which if a problem with a motor is detected it is shut down, and in which upon detection of a problem, the current supplied to a remaining operational motor is reduced.

46. A system as claimed in claim 32, comprising support legs.

47. A system as claimed in claim 32, comprising a case that surrounds the frame.

48. A system as claimed in claim 32, comprising a displacement transducer to determine the position of the mass block.

49. A structure provided with one or more systems as claimed in claim 32.

50. A structure as claimed in claim 49, in which the system is bolted to a surface or is free-standing.

51. An active mass damper device for reducing vibrations in a structure, the device comprising a stiff frame, the device further comprising one or more accelerometers which take instantaneous absolute measurements of vibrations in a structure, means for feeding the instantaneous absolute measurements to a control unit and using this to drive an actuator, in which the actuator moves a mass block substantially vertically in the stiff frame and the device comprises linear bearings to ensure substantially vertical motion of the mass block, the stiff frame transmits dynamic forces generated by the internal motion of the mass block to cancel out or dampen vibrations in the structure in use.
